(19) United States
(12) Patent Application Publication
(10) Pub. No.: US 2007/0218777 A1
(43) Pub. Date: Sep. 20, 2007

(54) Electric Contact and the Part of an Electric Connector Comprising Said Contact

(76) Inventor: Claude Casses, Clevilliers (FR)

Correspondence Address: HARRINGTON & SMITH, PC, 4 RESEARCH DRIVE, SHELTON, CT, 06484-6212, US

(21) Appl. No.: 11/578,498

(22) PCT Filed: Apr. 19, 2005
(86) PCT No.: PCT/EP05/04162

§ 371 Date: Oct. 12, 2006

(30) Foreign Application Priority Data
Apr. 19, 2004 (FR) 04/04121

(51) Int. Cl. H01R 13/432

(52) U.S. Cl. 439/746

(57) ABSTRACT

This contact includes a tubular body bounded by walls and a contract part attached to the inside of said tubular body, the body having an edge forming a shoulder provided for cooperating with a second shoulder formed by the end of a part of a socket of the connector insulating casing, and thereby assuring the locking in place of said contact in the direction of withdrawal from socket. It has, on a front section of the body, a slit formed by one of walls for enabling the body to be deformed by bending during the insertion of the contact into the socket. The invention also concerns a part of an electric connector including an insulating casing and said electric contact.

The present invention concerns a cage-type electric contact, comprising a tubular body bounded by walls, and a contact part which is attached to the inside of said tubular body, the body having an edge that forms a shoulder, provided to cooperate with a second shoulder formed by the end of a part of a socket of the insulating casing of a connector, and thus assuring the locking in place of the contact in the direction of withdrawal from the socket.

In the prior art, such contacts, which are provided to be locked in place in a corresponding socket of an insulating casing, for example, by means of an elastic latch molded in one piece with the casing, generally have a rigid body.

While an important trend in the field of electric connectors consists of miniaturization, this is limited notably by the necessary bending deflection of the latches and by their thickness. A sufficient thickness must, in fact, be given to the latches to assure satisfactory resistance against being pulled out.

In order to reduce the space necessary between two rows of contacts, and thus the overall space occupied by the connectors, it has already been proposed to create latches of small thickness and increased rigidity, functioning with slight deflection. In particular, certain connector casings are endowed with such latches, connected to the walls of the socket at their two ends, so that their bending deformation is reduced.

Such a rigidification of the latches, while it permits obtaining the same resistance against pulling out the contact while occupying a smaller space, is penalizing from the point of view of the force needed to insert the contact into the socket.

The object of the invention is to resolve this disadvantage, and to propose a contact of the above type that permits obtaining a force of an acceptable level for introducing the contact into the socket, when the contact is used with latches or other elastic locking components of great rigidity.

This object is attained by the invention, according to which a contact of the above-mentioned type comprises, on a front section of the body, a slit formed in one of the walls, designed to permit a bending deformation of the body during insertion of the contact into the socket.

The invention can also comprise one or more of the following characteristics:
the body is of a generally cylindrical shape with rectangular section, having two opposed lateral walls, as well as a floor wall and a ceiling wall, the slit being formed in a lateral wall, while the contact part projects from the ceiling wall;
the contact part is connected to the ceiling wall at the level of a rear section of the body;
the slit extends essentially axially;
the slit is open on the front side;
the slit extends over a length section that is less than half the length of the body;
the body is made from a metal blank by bending, and closed at the level of a junction line for the two opposite edges of the metal blank, and the junction is made on the side opposite the slit with a play permitting a bending deformation of the body;
the junction line extends essentially axially;
the electric contact has a second slit on a front section of the body, formed in the wall opposite the wall in which the first slit is formed, and preferably roughly symmetrical to said first slit;
the electric contact is made in one piece by bending a metal blank; and
the electric contact is made up of a female contact, whose contact part is a bent elastic blade extending inside the body.

The invention also pertains to an electric connector part, comprising an insulating casing, having at least one socket and at least one associated latch for locking the contact in place in said socket, and at least one contact such as described previously, engaged in said socket and locked in place inside it by cooperation of the latch with the rear shoulder of the body.

One particular embodiment of the invention will now be described in more detail, in reference to the attached drawings, in which:

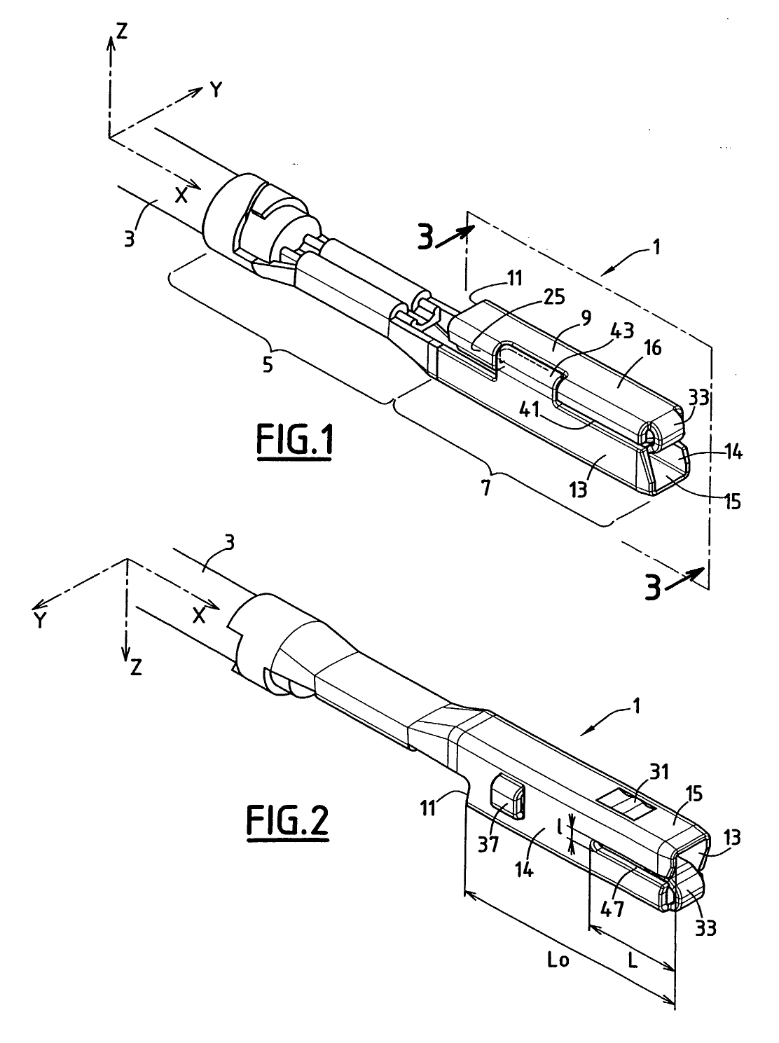

FIGS. 1 and 2 are perspective views, in two different directions, of a contact conforming to the invention;

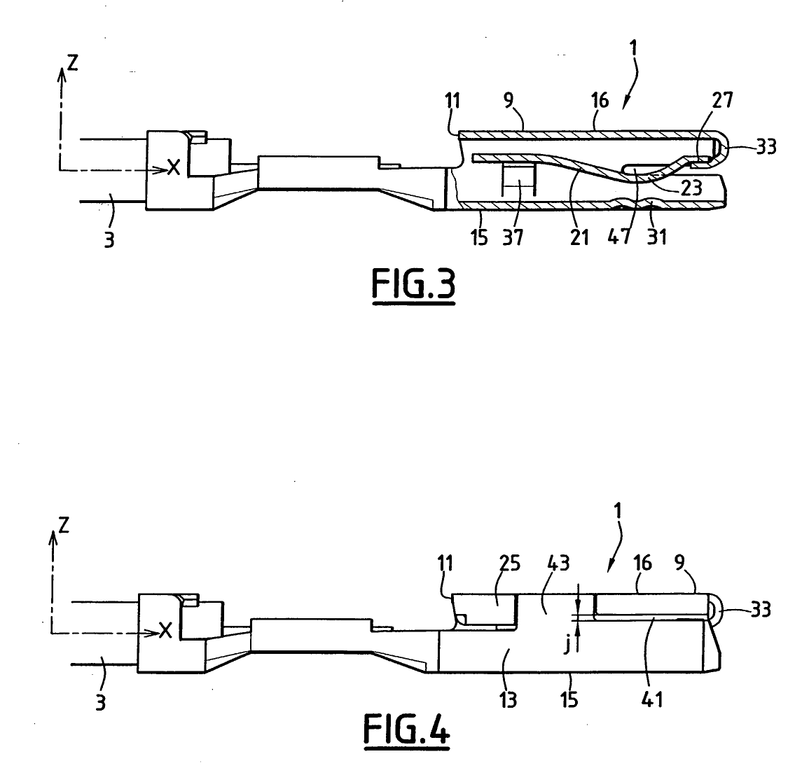

FIG. 3 is a sectional view, in a median longitudinal plane, of the contact of FIG. 1, along direction 3-3;

FIG. 4 is a side view, along direction 3-3, of the contact of FIG. 1; and

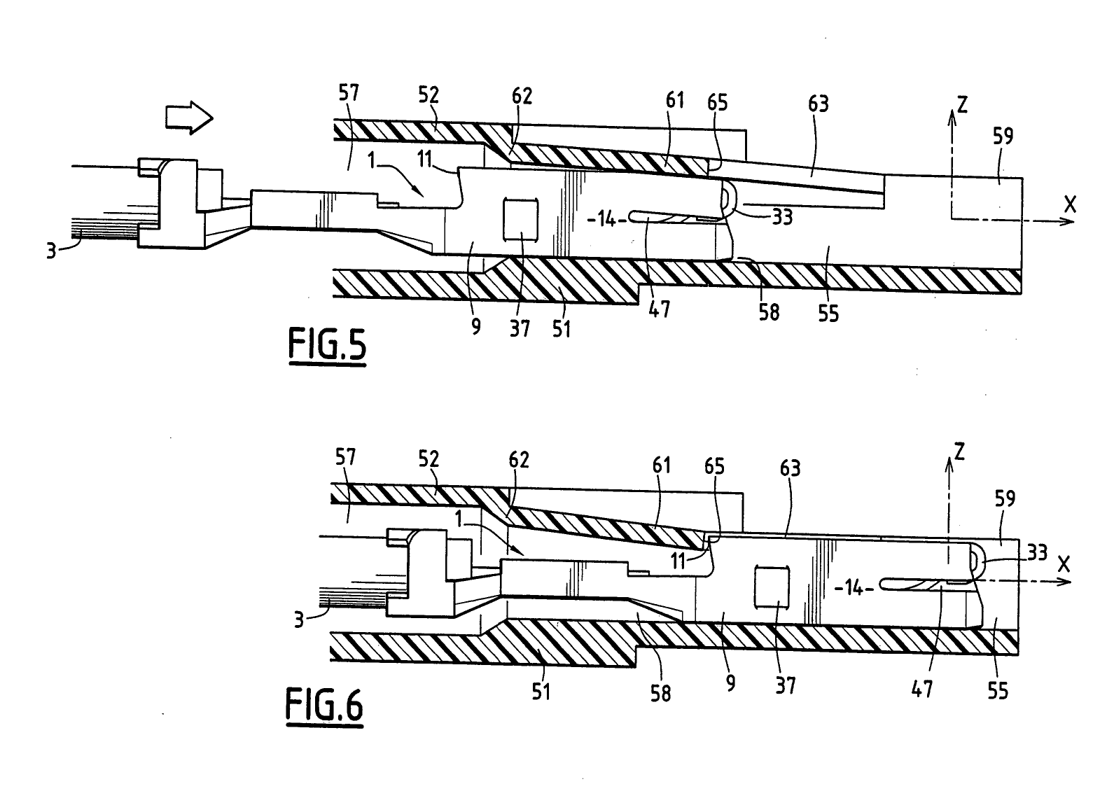

FIGS. 5 and 6 are schematic sectional views, in a median longitudinal plane, of a socket designed to receive and lock in place a contact such as illustrated in the preceding Figures, the contact being shown in side view (not sectional), in a position of partial engagement and in a position of complete engagement, respectively.

In FIGS. 1 to 4, a female electric contact 1 conforming to the invention is shown, crimped onto the end of an electric cable 3. This contact 1 is designed to be housed and fastened in a socket of an insulating casing of an electric connector.

In order to simplify the description which follows, the Figures are oriented according to a system of orthogonal X, Y and Z axes, in which:
the X axis is the longitudinal axis of the contact, considered to be oriented from front to back, corresponding to the direction of insertion of the contact into its socket and to the direction of mutual engagement of contact 1 with a complementary male contact;
the Y axis is the transverse axis, considered to be horizontal; and
the Z axis is considered to be vertical, oriented from bottom to top.

All terms for orientation and direction will be understood with regard to this system of axes. In particular, the term “axial” will mean an orientation in the direction of the X axis, this axis also defining the principal direction of cable 3, in the end binding region for contact 1.

Contact 1 comprises a section 5 for crimping onto cable 3, and a contact section 7, provided to receive a pin or tab terminal of a complementary male contact.

Of course, the invention is not limited to a contact of the type to be crimped, such as shown in the Figures. Any other type of joining to a cable, for example, joining by displacement or piercing the insulation, is compatible with the invention.

Female electric contact 1 illustrated in the Figures is of the “cage” type, in reference to the fact that the contact section 7 comprises a hollow tubular body 9, particularly provided to assure fastening of the contact in its socket.

Body 9 has a rear edge 11 for this purpose, forming a shoulder designed to cooperate with a retaining latch provided in the socket.

In the example shown, tubular body 9 is generally of cylindrical form with X axis, with a rectangular base. Body 9 forms a conduit inside for receiving the complementary component of the male contact, along longitudinal axis X.

Tubular body 9 is defined by four essentially flat and rectangular walls, i.e., two lateral walls 13, 14, a floor wall 15 and a ceiling wall 16. Lateral walls 13, 14, on the one hand, and floor wall 15 and ceiling wall 16, on the other hand, are opposite and parallel to each other.

Contact section 7 also comprises a contact part in the shape of an elastic blade 21, which is bent inside body 9, in the conduit.

Contact blade 21 essentially extends in the axial direction inside body 9, with a convex profile 23 facing floor wall 15. The contact blade 21 projects into body 9 from ceiling wall 16, while being bound to this ceiling by means of a lateral prong 25 bent transversely towards the inside of body 9, from the rear side of this body.

Blade 21 has a free end 27 on the front side of the body.

Body 9 is provided to receive the complementary component of the male contact between blade 21 and floor wall 15, profile 23 constituting an active part provided to press against this male component, and thus define a privileged passage region for current between the male contact and the female contact. In a corresponding manner, floor wall 15 is formed with a relief piece, in this case a double-boss piece 31 facing profile 23, in order to improve the contact pressure.

Body 9 is also endowed with a protection strip 33 projecting axially from ceiling wall 16 from its front edge, and curved back towards the inside, so that its free end defines a support for free end 27 of blade 21 (FIG. 3). This protection strip 33 has the first function of preventing the introduction of a male component between blade 21 and ceiling wall 16. It also assures a pre-stressing of contact blade 21 by bending, by pushing it slightly away from floor wall 15, so as to reduce the force necessary for insertion of the male contact component into the female contact 1.

Moreover, body 9 is formed laterally with a relief piece 37, obtained, for example, by stamping a part of lateral wall 14. Relief piece 37 projects laterally toward the outside of the body, and assures making the contact in the socket foolproof, so that the contact can only be engaged completely and locked in the socket in its correct functional orientation.

As can be seen in the Figures, contact 1, in the example shown, is made in a single piece from a metal strip. The contact is obtained by successive operations of cutting, stamping and bending.

At the end of a certain number of cutting operations of the metal strip, the metal blank thus obtained is bent so, as to give body 9 its closed tubular configuration. The body is closed by means of joining the two opposite edges of the metal blank, along a line 41. In order to prevent deformation of the body by twisting and relative axial sliding of the edges defining junction line 41, an interlocking joint is created at the level of this junction line 41, consisting of a tab 43 from lateral wall 13 into a corresponding notch of ceiling wall 16.

The body is closed and the interlocking joint is created so that junction line 41 has a certain daylight or play j permitting a slight compression of body 9 along vertical axis Z at the level of junction line 41. This play j of the junction will be described in detail in the following.

In lateral wall 14, opposite to lateral wall 13 on which junction line 41 extends, an essentially axial slit 47 is formed, which extends from the front edge of wall 14 over a front section of body 9. The length L of the slit or slot 47, in the example shown, is less than half of the total length L₀ of body 9, this length L₀ being definable as the distance between rear edge 11 forming the shoulder and the front-most part of the contact. Slit 47 is open from the front side of lateral wall 13.

Slit 47 is provided so that body 9 is slightly deformable by compression along vertical axis Z, over a front section of the body. In other words, slit 47 is provided, in order to permit, from the front side, a bending of ceiling wall 16 relative to floor wall 15, so that these walls can be moved closer together in the front by elastic bending.

More precisely, it will be noted that slit 47 extends in an axial rectilinear manner, and halfway up wall 14.

In order to assure a homogeneous deformation from one side to the other of body 9, slit 47 has a width l of the same order as play j formed at the level of junction line 41, preferably roughly equal to it.

By referring to FIGS. 5 and 6, one can better perceive the behavior of contact 1, described previously, during its insertion into a socket of the insulating casing of the electric connector, provided for receiving such a contact.

In these Figures, the shape of such a socket, as well as the contact described previously, have been diagramed sectionally, in an axial plane, in successive phases of engagement in the socket: in FIG. 5, the contact is shown in a partial engagement phase, while in FIG. 6, the contact is shown in its position of complete engagement.

In these Figures, lower wall 51 and upper wall 52 of an insulating connector casing are shown, defining between them a socket 55 for receiving the contact.

Socket 55 essentially comprises a socket entrance part 57, and an intermediate socket part 58, and a front portion 59 for receiving contact body 9.

Lower wall 51 is provided in order to cooperate with floor wall 15 of the contact during its insertion.

The casing, which has been partially diagramed in FIGS. 5 and 6, has, for socket 55, a latch 61 made in one piece with upper wall 52. This latch 61 extends essentially in the axial direction X projecting towards the inside of intermediate socket part 58. Latch 61 is connected by its rear end to upper wall 52, with which it is molded in one piece, by a junction region 62. It is also connected, from its front end, to upper wall 52 by two axial straps 63.

Latch 61 is thus elastically deformable by bending, but has great rigidity and slight deflection.

From its front end side, latch 61 has an edge 65 complementary to shoulder 11, formed by the rear edge of body 9 of the contact.

From the rear side of the latch, junction region 62 at upper wall 52 defines a contraction of the socket, and thus a hard point for the passage of the contact during its insertion.

FIG. 5 illustrates the fact that at the passage of body 9 into the intermediate socket part 58, starting from the passage of hard point 62, body 9 is deformed at the front by bending (or by compression) by means of the effect of latch 61.

Thus, the insertion of the contact into the socket is translated not only by an elastic deformation of latch 61, as is the case in the manner of the prior art, but also by a conjugate deformation of the front part of body 9, due to the presence of slit 47.

It is understood that the force of insertion necessary for the introduction of the contact into the socket, and, in particular, for the passage of hard point 62, is minimized due to the presence of slit 47 on the contact.

In FIG. 6 the contact is shown in its complete engagement position, in which it is locked in functioning position inside socket 55, after elastic rebound of latch 61 into its stable rest position, in which front edge 65 of the latch cooperates with rear edge 11 of the contact, by opposing its removal toward the back. As illustrated in this Figure, body 9 of the contact again takes on its non-deformed configuration in this position, by elastic rebound of the constitutive walls of the body into their nominal position.

It goes without saying that the invention is adapted to any type of catching component functioning with an elastic deformation, however weak it is, which is illustrated here by a bar provided with a catching piece and deformable by bending, and which we have designated by the term “latch”. Also, this term is generally extended to any part of the wall of the socket or of any component connected to a wall of the socket, which catches the contact inside this socket and functions by elastic deformation.

It is important to note that, due to the fact that joining prong 25 of contact blade 21 with ceiling wall 16 is situated on the rear side of body 9, the elasticity given by slit 47 to the front of the body does not disrupt the contact pressure of the contact blade 21 on the complementary male component. In fact, contact blade 21 is connected to a rigid part of the body that is not influenced by the bending elastic deformations of the front part.

According to one alternative embodiment, which has not been shown, body 9 has a second slit analogous to slit 47, formed in wall 13. Preferably, such a second slit is symmetrical to the first slit 47, so as to assure a symmetrical bending deformation of body 9 during insertion of the contact into the socket.

In this embodiment, since the bending deformation capacity of the body is obtained by two slits, junction 41 can be provided without play, preferably on ceiling wall 16. The opposite edges defining junction line 41 can then be advantageously soldered or clipped.

The invention that has just been described permits reconciling a high degree of miniaturization of connectors with maintaining insertion forces and forces holding the contacts in the sockets at satisfactory levels.

1. An electric contact, comprising a tubular body bounded by walls, and a contact part which is attached inside said tubular body, body having an edge that forms a shoulder, provided to cooperate with a second shoulder formed by the end of a part of a socket of the insulating connector casing, and thus to assure the locking in place of contact in the direction of withdrawal from socket,
characterized in that it comprises, in a front section of the body, a slit formed in one of the walls, adapted to permit a bending deformation of body during insertion of contact into socket.

2. The electric contact according to claim 1, further characterized in that body is generally cylindrical with a rectangular section, having two opposite lateral walls, as well as a floor wall and a ceiling wall, slit being formed in a lateral wall, while contact part projects from ceiling wall.

3. The electric contact according to claim 2, further characterized in that contact part is connected to ceiling wall at the level of a rear section of body.

4. The electric contact according to claim 1, further characterized in that slit extends essentially axially (X).

5. The electric contact according to claim 1, further characterized in that slit is open from the front part.

6. The electric contact according to claim 1, further characterized in that slit extends over a section of a length that is less than half the length of body.

7. The electric contact according to claim 1, further characterized in that body is made from a metal blank by folding, and closed at the level of a junction line of two opposite edges of the metal blank, and in that junction is made on the side opposite slit, with a play (j) permitting a bending deformation of the body.

8. The electric contact according to claim 7, further characterized in that junction line extends essentially axially (X).

9. The electric contact according to claim 1, further characterized in that it comprises a second slit on a front section of the body, formed in wall opposite wall in which the first slit is formed, preferably roughly symmetrical with said first slit.

10. The electric contact according to claim 1, further characterized in that it is made in one piece by bending a metal blank.

11. The electric contact according to claim 1, further characterized in that it is made up of a female contact, whose contact part is a bent elastic blade extending inside body.

12. An electric connector part, comprising at least an insulating casing, having at least one socket and at least one associated latch for locking a contact in place in said socket, and at least one contact according to claim 1, engaged in said socket and locked inside it by cooperation of latch with rear shoulder of body.
